(19) United States
(12) Patent Application Publication
(10) Pub. No.: US 2025/0217311 A1
(43) Pub. Date: Jul. 3, 2025

(54) MANY-CORE PROCESSING APPARATUS, DATA PROCESSING METHOD, AND DEVICE AND MEDIUM

(71) Applicant: LYNXI TECHNOLOGIES CO., LTD., Haidian District, Beijing (CN)

(72) Inventors: Wei HE, Haidian District, Beijing (CN); Yaolong ZHU, Haidian District, Beijing (CN)

(21) Appl. No.: 18/852,421

(22) PCT Filed: Apr. 7, 2023
(86) PCT No.: PCT/CN2023/087032

§ 371 Date: Sep. 27, 2024

(30) Foreign Application Priority Data
Apr. 8, 2022 (CN) 202210367443.9
Apr. 8, 2022 (CN) 202210368719.5

(51) Int. Cl. G06F 15/80

(52) U.S. Cl. CPC G06F 15/80

(57) ABSTRACT

A many-core processing apparatus, a data processing method, and a device and a medium. The many-core processing apparatus comprises: a first chip and at least one second chip which are arranged in a stacked manner, wherein the first chip comprises a plurality of computing cores, the at least one second chip forms a storage chip group, and the second chip comprises a plurality of storage cores; at least one computing core in the first chip is connected to at least one storage core in the storage chip group.

### FIELD OF TECHNOLOGY

The present disclosure relates to the field of computer technology, specifically to a many-core processing apparatus, a data processing method and electronic device, and a computer-readable storage medium.

### BACKGROUND

There is a need for data transmission between different chips. Considering the cost factors of chip packaging and wiring, connecting lines between chips should be as few as possible. Additionally, when using standard input-output interface units, the maximum achievable transmission rate is a fixed value.

### SUMMARY

Embodiments of the present disclosure provide a many-core processing apparatus, a data processing method and an electronic device, as well as a computer-readable storage medium.

In the first aspect, an embodiment of the present disclosure provides a many-core processing apparatus, comprising: a first chip and at least one second chip arranged in a stacked manner, the first chip comprises a plurality of computing cores, the at least one second chip forms a storage chip group, and the second chip comprises a plurality of storage cores;

at least one computing core in the first chip is connected to at least one storage core in the storage chip group.

In the second aspect, an embodiment of the present disclosure provides a data processing method, applied to the many-core processing apparatus according to any embodiment of the present disclosure, the many-core processing apparatus comprises a first chip and at least one second chip arranged in a stacked manner, the first chip comprises a plurality of computing cores, the at least one second chip forms a storage chip group, the second chip comprises a plurality of storage cores, and at least one computing core is connected to at least one storage core; the method comprising:

in response to received data operation instructions, processing data in a corresponding storage core.

In the third aspect, an embodiment of the present disclosure provides an electronic device, comprising a memory, a processor, and a computer program stored in the memory and executable on the processor, when the processor executes the computer program, the data processing method according to any embodiment of the present disclosure is implemented.

In the fourth aspect, an embodiment of the present disclosure provides a computer-readable storage medium having a computer program stored thereon, when the computer program is executed by a processor, the data processing method according to any embodiment of the present disclosure is implemented.

In the fifth aspect, an embodiment of the present disclosure provides computer-readable code or a non-volatile computer-readable storage medium carrying the computer-readable code, wherein, when the computer-readable code runs in a processor of an electronic device, the processor in the electronic device executes the data processing method according to any embodiment of the present disclosure.

In the embodiments of the present disclosure, a chip based on computing cores and a chip based on storage cores are stacked to form the corresponding many-core processing apparatus; wherein the computing cores can quickly read or write data from or to the connected storage cores, reducing the transmission pressure caused by centralized data transmission, increasing the bandwidth for data transmission between chips, thereby improving data transmission rate, while also effectively reducing the chip area.

It should be understood that the above general description and the detailed description below are only illustrative and explanatory, and are not restrictive of this disclosure. Other features and aspects of the present disclosure will become clear from the detailed description of exemplary embodiments with reference to the accompanying drawings.

### BRIEF DESCRIPTION OF THE DRAWINGS

FIG. 1 is a schematic diagram of a many-core processing apparatus provided by an embodiment of the present disclosure.

FIG. 2a is a schematic diagram of a many-core processing apparatus provided by an embodiment of the present disclosure.

FIG. 2b is a schematic diagram of a many-core processing apparatus provided by an embodiment of the present disclosure.

FIG. 3 is a cross-sectional schematic diagram of a many-core processing apparatus provided by an embodiment of the present disclosure.

FIG. 4 is a cross-sectional schematic diagram of a many-core processing apparatus provided by an embodiment of the present disclosure.

FIG. 5 is a cross-sectional schematic diagram of a many-core processing apparatus provided by an embodiment of the present disclosure.

FIG. 6 is a schematic diagram of a many-core processing apparatus provided by an embodiment of the present disclosure.

FIG. 7 is a schematic diagram of a many-core processing apparatus provided by an embodiment of the present disclosure.

FIG. 8 is a schematic diagram of a many-core processing apparatus provided by an embodiment of the present disclosure.

FIG. 9 is a cross-sectional schematic diagram of a many-core processing apparatus provided by an embodiment of the present disclosure.

FIG. 10 is a schematic diagram of a many-core processing apparatus provided by an embodiment of the present disclosure.

FIG. 11 is a schematic diagram of a many-core processing apparatus provided by an embodiment of the present disclosure.

FIG. 12 is a schematic diagram of a many-core processing apparatus provided by an embodiment of the present disclosure.

FIG. 13 is a schematic diagram of a many-core processing apparatus provided by an embodiment of the present disclosure.

FIG. 14 is a schematic diagram of a many-core processing apparatus provided by an embodiment of the present disclosure.

FIG. 15 is a schematic diagram of a many-core processing apparatus provided by an embodiment of the present disclosure.

FIG. 16 is a schematic diagram of a many-core processing apparatus provided by an embodiment of the present disclosure.

FIG. 17 is a schematic diagram of a many-core processing apparatus provided by an embodiment of the present disclosure.

FIG. 18 is a schematic diagram of a many-core processing apparatus provided by an embodiment of the present disclosure.

FIG. 19 is a schematic diagram of a many-core processing apparatus provided by an embodiment of the present disclosure.

FIG. 20 is a flowchart of a data processing method provided by an embodiment of the present disclosure.

FIG. 21 is a block diagram of an electronic device provided by an embodiment of the present disclosure.

FIG. 22 is a block diagram of a computer-readable storage medium provided by an embodiment of the present disclosure.

### DESCRIPTION OF THE EMBODIMENTS

Below, the present disclosure is further described in detail with reference to the accompanying drawings and embodiments. It should be understood that the embodiments described here are solely for the purpose of explaining the present disclosure, not to limit it. Additionally, to facilitate the description, only parts relevant to the present disclosure rather than the entire structure are shown in the accompanying drawings.

In related technology, multiple chip units are typically packaged in a two-dimensional manner on a substrate to form a chip with more functions. To control the cost of the chip, the connection lines between the chip units should be as few as possible. This will limit the bit width of parallel data transmission, easily leading to centralized data transmission, which impacts the bandwidth. Furthermore, due to the limitations of a two-dimensional layout, the length of connection lines often cannot be kept short, which easily causes transmission delays. Additionally, when there are many chip units, the chip area becomes excessively large.

According to the many-core processing apparatus in an embodiment of the present disclosure, the first chip and at least one second chip are arranged in a stacked manner, which not only reduces the chip area but also increases the data transmission bandwidth.

In the first aspect, the embodiment of the present disclosure provides a many-core processing apparatus.

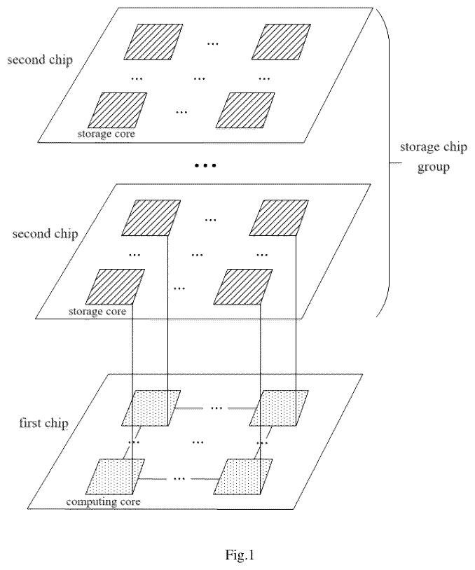

FIG. 1 is a schematic diagram of a many-core processing apparatus provided by this embodiment of the present disclosure. Referring to FIG. 1, the many-core processing apparatus comprise a first chip and at least one second chip arranged in a stacked manner, the first chip comprises a plurality of computing cores, the at least one second chip forms a storage chip group, and the second chip comprises a plurality of storage cores; at least one computing core in the first chip is connected to at least one storage core in the storage chip group.

In other words, the many-core processing apparatus comprises at least a first chip with the data processing capability (the first chip is also referred to as the computing chip) and a second chip with the data storage capability (the second chip is also referred to as the storage chip). The first chip may comprise a plurality of computing cores, the second chip may comprise a plurality of storage cores, and there may be one or more second chips. Furthermore, the plurality of second chips can form a corresponding storage chip group based on a stacked manner, and the first chip can be further stacked above or below the storage chip group. Additionally, to ensure that the computing cores can utilize the data storage function of the storage cores, and the storage cores can utilize the data processing capability of the computing cores, at least one computing core in the first chip is connected to at least one storage core in the storage chip group to ensure data transmission therebetween and enable data processing and storage operations based on the data transmission.

In some possible implementations, the many-core processing apparatus consists of one first chip and one second chip arranged in a stacked manner, that is, the storage chip group may include only one second chip, which is stacked with the first chip to form a many-core processing apparatus with data processing and data storage capabilities.

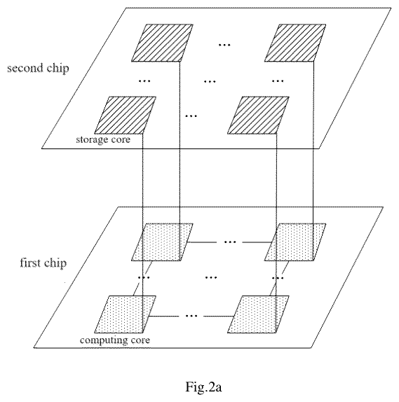

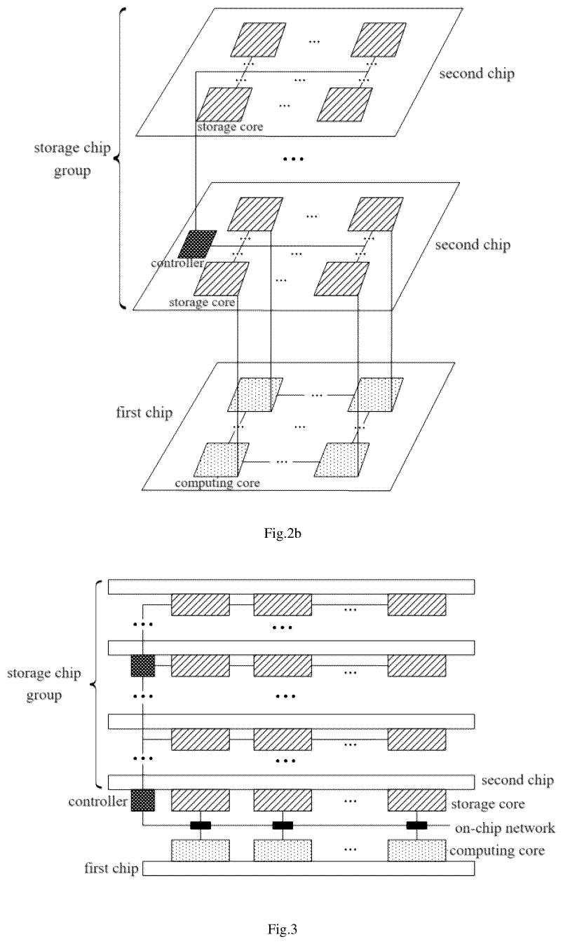

FIG. 2a is a schematic diagram of a multi-core processing apparatus provided by an embodiment of the present disclosure. Referring to FIG. 2a, the multi-core processing apparatus comprises a first chip and a second chip arranged in a stacked manner, the first chip is provided with a plurality of computing cores, and the second chip is provided with a plurality of storage cores; at least one computing core in the first chip is connected to at least one storage core in the second chip.

Exemplarily, the many-core processing apparatus comprises a first chip and a second chip arranged in a stacked manner, the first chip is provided with a plurality of computing cores, and the second chip is provided with a plurality of storage cores; at least one computing core in the first chip is connected to at least one storage core in the second chip.

In some possible implementations, the first chip is an intelligent chip based on many-core technology.

In one example, the computing cores in the first chip have independent storage space, allowing the first chip to achieve integrated computing and storage, which is suitable for applications requiring large-scale parallel processing of big data (e.g., in deep learning scenarios).

In one example, the first chip also comprises an on-chip network, enabling large-scale, highly parallel, low-latency communication between computing cores via the on-chip network.

In some possible implementations, if the storage space of the computing cores in the first chip is limited and cannot meet preset usage requirements, the computing cores can utilize external storage space to increase available storage resources.

In some possible implementations, the computing cores of the first chip can utilize the storage space of the storage cores in the second chip. For example, both the first chip and the second chip are chips within the many-core processing apparatus, the second chip is provided with a plurality of storage cores, and each storage core has corresponding storage space and provides a certain amount of storage resources. The computing cores in the first chip are connected to the storage cores in the second chip to use the storage resources of the storage cores.

In some possible implementations, the first chip and the second chip are arranged in a stacked manner.

The stacked manner is relative to arranging chips only in a two-dimensional plane. By arranging chips in a stacked manner, the chips have extended functionality and signaling in the vertical direction (Z-axis). Additionally, arranging chips in a stacked manner can reduce the chip area while also shortening the communication path between the chips, thereby increasing the bandwidth and the data transmission rate.

In one example, the first chip and the second chip can be stacked in a face-to-face manner, meaning that both the bottom layers of the first and second chips are oriented outward, allowing the top layers of the two chips to come into direct contact.

In one example, the first chip and the second chip can be stacked sequentially, meaning that the bottom layer of the second chip is in contact with the top layer of the first chip, with the two being placed in sequence.

It should be understood that when using a face-to-face stacking manner, the computing cores and storage cores are connected directly without the need for Through Silicon Via (TSV) technology to create vias, resulting in faster data transmission rate. In contrast, when using the sequential stacking manner, it may be necessary to use TSV technology to create at least one via for establishing a connection between the computing cores and storage cores, which may result in slower transmission rate compared to the face-to-face stacking manner.

In some possible implementations, when a single second chip cannot meet the requirements of the first chip, the first chip can utilize storage resources of a plurality of second chips to satisfy its usage requirements.

In some possible implementations, there are a plurality of second chips external to the first chip, each including a plurality of storage cores with corresponding storage space, and these second chips are stacked to form a corresponding storage chip group. The computing cores in the first chip are connected to one or more storage cores in the storage chip group to utilize the storage resources of the storage chip group.

Exemplarily, the many-core processing apparatus comprise a first chip and a storage chip group arranged in a stacked manner, the first chip comprises a plurality of computing cores, the storage chip group comprises a plurality of second chips arranged in a stacked manner, and at least part of the second chips comprises a plurality of storage cores. The computing cores in the first chip are connected to the storage cores in the storage chip group to utilize the storage resources of the storage chip group.

In one example, the aforementioned plurality of chips can be arranged in a face-to-face stacking manner. For the first chip and the storage chip group, the face-to-face stacking manner involves directly contacting the top layer of the first chip with the top layer of the adjacent second chip, while the bottom layer of the first chip and the bottom layer of the adjacent second chip are oriented outward. For the second chips in the storage chip group, the face-to-face stacking manner involves directly contacting the top layers of two second chips, with the bottom layers oriented outward.

In one example, the aforementioned plurality of chips can be arranged in a sequential stacking manner. For the first chip and the storage chip group, the sequential stacking manner involves directly contacting the top layer of the first chip with the bottom layer of the adjacent second chip, with the two chips placed in sequence. For the second chips in the storage chip group, the sequential stacking manner involves directly contacting the top layer of each second chip with the bottom layer of the adjacent second chip, with the chips placed in sequence.

It should be noted that, in some possible implementations, different stacking methods can be used for the first chip and the storage chip group, and the plurality of second chips in the storage chip group. For example, the storage chip group includes N second chips (where N is an integer greater than or equal to 3), with the first to the (N−1)th second chips arranged in the sequential stacking manner, and the Nth second chip arranged in the face-to-face stacking manner with the first chip.

In some possible implementations, to effectively control the storage chip group and achieve efficient utilization of storage resources, a controller may be provided in the storage chip group to control orderly transmission of data within the storage chip group as well as between the storage chip group and external units (e.g., the first chip).

In some possible implementations, a controller can be provided in at least one second chip in the storage chip group, with each second chip connected via the controller. This controller can control data transmission within each chip and between various chips of the many-core processing apparatus. For example, the controller can control data transmission within the second chip, between second chips, and between the second chip and the first chip.

FIG. 2b is a schematic diagram of a many-core processing apparatus provided by an embodiment of the present disclosure. Referring to FIG. 2b, the multi-core processing apparatus comprises a first chip and a storage chip group arranged in a stacked manner, the first chip comprises a plurality of computing cores, the storage chip group comprises a plurality of second chips arranged in a stacked manner, the second chip comprises a plurality of storage cores, and at least one second chip is provided with a controller. The controller is configured to control data transmission within at least part of the chips and between at least part of the chips in the many-core processing apparatus (e.g., the controller can control data transmission within each chip and between the various chips of the many-core processing apparatus); the second chips are connected via the controller, and at least one computing core in the first chip is connected to at least one storage core in the storage chip group.

In some possible implementations, the storage chip group comprises at least one non-volatile storage chip and/or at least one volatile storage chip arranged in a stacked manner; or, the storage chip group comprises a plurality of volatile storage chips arranged in a stacked manner; or, the storage chip group comprises a plurality of non-volatile storage chips arranged in a stacked manner. In other words, the second chip can be a volatile storage chip and/or non-volatile storage chip.

It should be understood that storage cores in the non-volatile storage chips have non-volatile storage characteristics, which can use Random Access Memory (RAM) and the like; storage cores in the volatile storage chips have volatile storage characteristics, which can use Read-Only Memory (ROM) and/or Flash Memory and the like. The present disclosure does not impose limitations on this aspect.

In some possible implementations, to accommodate more application scenarios and enhance the flexibility of controlling storage cores, the controller can be configured as a general controller and a distributed controller. The general controller is a centralized controller typically used to control a larger number of storage cores, while the sub-controller is a decentralized controller typically used to control fewer storage cores.

In some possible implementations, the general controller is at least configured to control the plurality of storage cores within the second chip (for example, the general controller can control all the storage cores within the second chip where it is located). The sub-controller is configured to control at least one storage core within the second chip where it is located, and both the general controller and sub-controller can be provided in a storage chip group.

For example, the general controller is arranged on the second chip relatively independent (relatively independent to the storage cores) to control the plurality storage cores in the second chip where it is located (e.g., the general controller controls all the storage cores in the second chip where it is located).

For example, the general controller is arranged on a volatile storage chip, it controls not only the plurality of storage cores in the volatile storage chip where it is located but also the storage cores on other volatile storage chips in the storage chip group that do not have their own controllers.

For example, each storage core on the second chip may include a sub-controller, which controls the corresponding storage core.

For example, a plurality of storage cores on the second chip share a single sub-controller, which can control the plurality of storage cores.

For example, the current storage core has a corresponding relationship with the storage cores on other second chips, the sub-controller of the current storage core can control not only the current storage core but also the storage cores having the corresponding relationship with the current storage core.

It should be noted that the control logic and functions of the general controller are generally more complex and varied compared to those of the sub-controller. Therefore, the chip area occupied by the general controller is typically larger than that of the sub-controller. In some cases, the sub-controller can be integrated within the storage core, which further reduces the chip area occupied by the controller. As a result, using the sub-controller can reduce the chip area occupied to a certain extent compared to using the general controller, which allows more chip area to be allocated for the placement of storage units (e.g., storage cores), thereby increasing the chip's storage space without changing the chip's area by accommodating more storage cores. In practical applications, any one or more types of controllers can be selected to control the second chips in the storage chip group according to actual requirements or empirical data, and the present disclosure does not impose any restrictions on this aspect.

The following will explain the chip stacking manner of the many-core processing apparatus according to an embodiment of the present disclosure in conjunction with FIG. 3 to FIG. 5.

FIG. 3 is a cross-sectional schematic of a many-core processing apparatus provided by an embodiment of the present disclosure. Referring to FIG. 3, the respective second chips in the storage chip group are arranged in a sequential stacking manner, and the top surfaces of the second chips face the negative direction of the Z-axis (i.e., downward in FIG. 3). Exemplarily, one controller is provided on each of the two second chips in the storage chip group, and these two controllers are connected. Each controller connects to all the storage cores in the second chip where it is located and to the storage cores in several adjacent second chips.

The top surface of the first chip faces the positive direction of the Z-axis (i.e., upward in FIG. 3) and is stacked below the storage chip group, such that the first chip is arranged in a face-to-face stacking manner with the adjacent second chip. Additionally, in the first chip, each computing core communicates through its on-chip network, and the storage cores in the second chip adjacent to the first chip establish connections to corresponding computing cores through connections to corresponding routing nodes in the on-chip network.

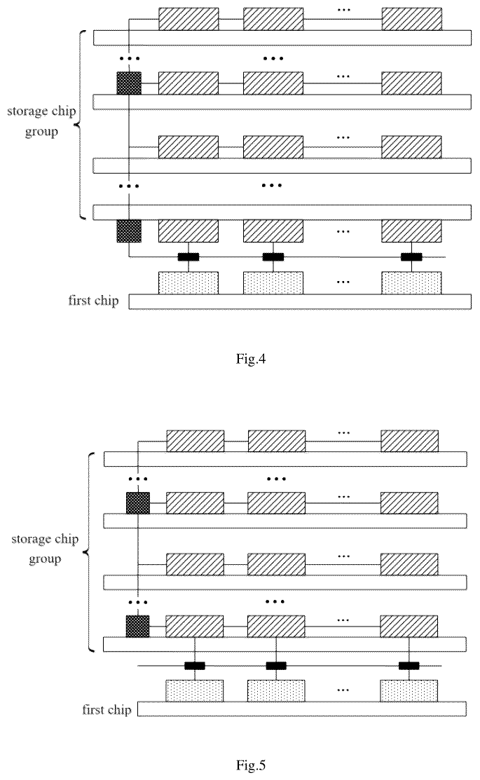

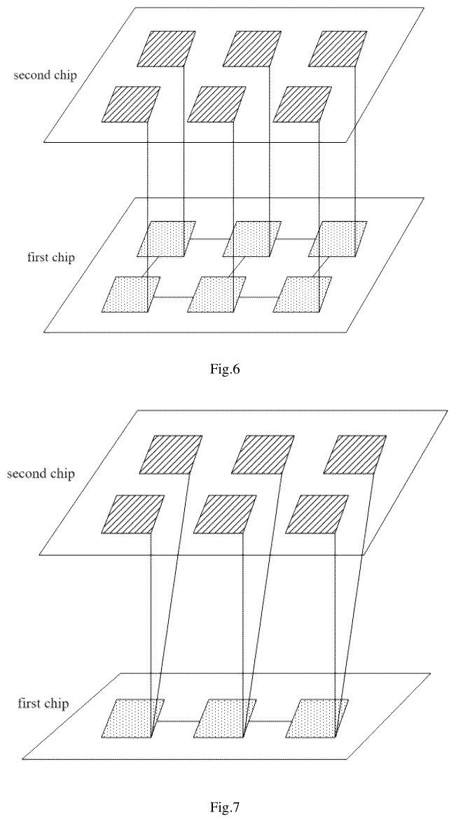

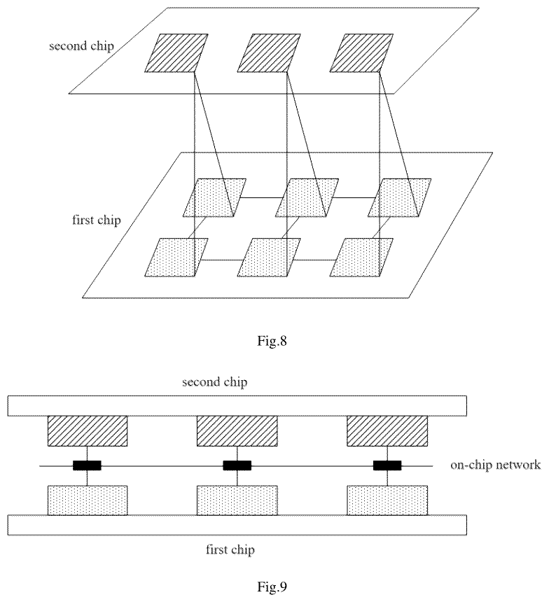

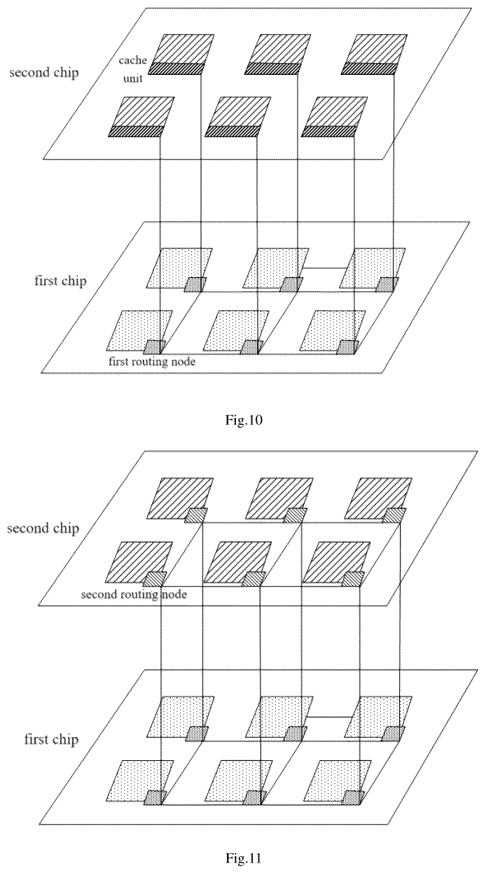

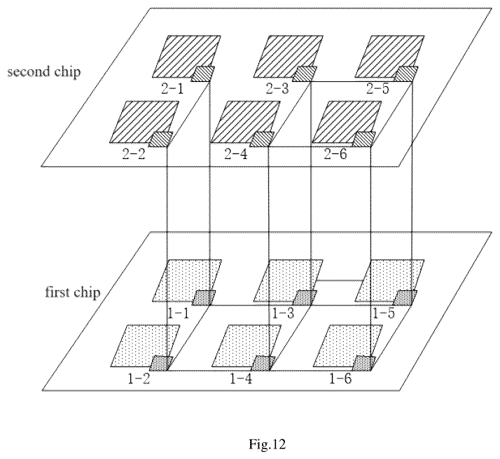

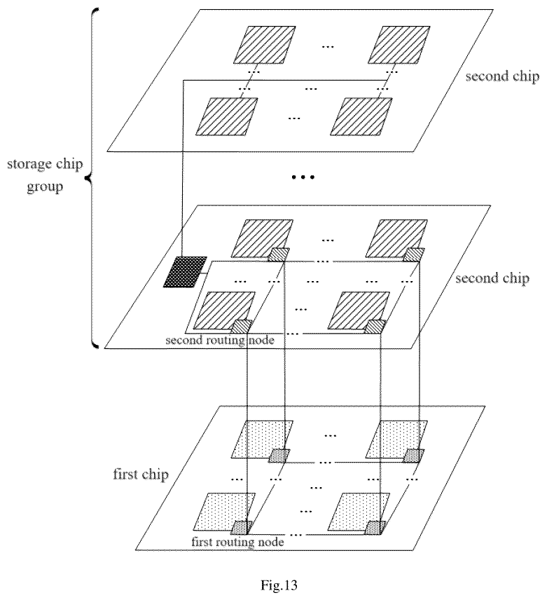

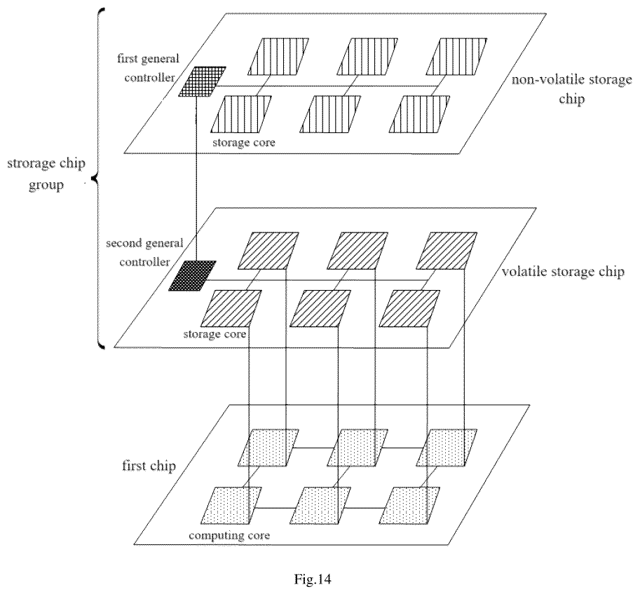

FIG. 4 is a cross-sectional schematic of a many-core processing apparatus provided by an embodiment of the present disclosure. Referring to FIG. 4, in the storage chip group, in the Z-axis direction, the second chip at the lowest layer faces the negative direction of the Z-axis, while the remaining multiple second chips face the positive direction of the Z-axis. Except for the last second chip, the remaining multiple second chips are arranged in a sequential stacking manner. Additionally, the last second chip and the first chip are arranged in a face-to-face stacking manner.

FIG. 5 is a cross-sectional schematic of a many-core processing apparatus provided by an embodiment of the present disclosure. Referring to FIG. 5, the top layer of each second chip in the storage chip group and the top layer of the first chip are oriented toward the positive direction of the Z-axis, and the plurality of second chips and the first chip are connected in a sequential stacking manner. Similarly, each second chip and the first chip can also be oriented toward the negative direction of the Z-axis and stacked sequentially (not shown in the figure).

It should be understood that when using the face-to-face stacking manner, the computing cores and storage cores are connected directly without the need for Through Silicon Via (TSV) technology to create vias, resulting in faster data transmission rate. In contrast, when using the sequential stacking manner, it may be necessary to use TSV technology to create at least one via to establish a connection between the computing cores and storage cores, which may result in slower transmission rate compared to the face-to-face stacking manner.

It should be noted that the above description of chip stacking methods are merely examples; embodiments of the present disclosure do not impose restrictions on the stacking methods within the storage chip group or between the storage chip group and the first chip.

It should also be noted that, regardless of the stacking method used, at least one computing core in the first chip should be connected to at least one storage core in the second chip. This connection implies that the first chip and the second chip are not entirely independent of each other, and data transmission between them is possible. However, the disclosure does not specify the exact number of computing cores and storage cores that should be connected, nor does it define the specific connection relationship between them.

For example, in the first chip, a certain computing core may be connected to storage cores in one second chip, or to storage cores in multiple second chips. Additionally, the computing core may be connected to one or multiple storage cores in a given second chip, or multiple computing cores may be connected to one storage core in the second chip or multiple computers cores are connected to multiple storage cores in the second chip. Embodiments of the present disclosure do not impose restrictions on these configurations.

Correspondingly, within the first chip, some computing cores may be connected to storage cores while others are not connected to storage cores; in the second chip, there may be a case where some storage cores are connected to computing cores while others are not connected to computing cores.

It should be noted that a computing core that is not connected to the storage core in the second chip does not mean that the computing core is not connected to other modules (other modules may be functional modules in the many-core processing apparatus or functional modules outside the many-core processing apparatus), and a storage core that is not connected to the computing core in the first chip does not mean that the storage core is not connected to other modules, and the present disclosure does not limit this.

For example, a computing core in the first chip that is not connected to the storage core of the second chip connects to a storage core in a third chip; in another example, a storage core in the second chip that is not connected to the computing core of the first chip connects to a computing core in a fourth chip, wherein the third chip and the fourth chip are chips other than the first chip and the second chip.

In some possible implementations, at least part of the computing cores in the first chip constitutes a first array, and at least part of the storage cores in the second chip constitutes a second array; the computing cores in the first array have a corresponding relationship with the storage cores in the second array, and the computing cores and storage cores having the corresponding relationship are connected.

At least part of the computing cores constitutes the first array comprises two cases: part of the computing cores in the first chip constitute the first array, and all of the computing cores in the first chip constitute the first array.

For the second array, it can be divided into two cases: in the first case, the storage chip group comprises only one second chip. In this case, the second array is similar to the first array, and it can be composed of some of the storage cores in the second chip or all of the storage cores in the second chip. In the second case, the storage chip group comprises a plurality of second chips. In this case, the second array comprises a two-dimensional plane storage array and a three-dimensional space storage array, wherein the second array composed of some of the storage cores of a certain second chip and the second array composed of all the storage cores of a certain second chip belong to the two-dimensional plane storage array, and the second array composed of some of the storage cores of the plurality of second chips, the second array composed of all the storage cores of the plurality of second chips, and the second array composed of all the storage cores of all second chips belong to the three-dimensional space storage array (since the plurality of second chips are stacked in a direction perpendicular to the second chip, the second array is a storage array with three-dimensional space characteristics).

In some possible implementations, for the second array, considering that the second chip may include a volatile storage chip and/or a non-volatile storage chip, therefore, from the perspective of volatile storage and non-volatile storage, the second array may include a second volatile storage array and a second non-volatile storage array, wherein the second volatile storage array is an array based on the first storage cores in the volatile storage chip, and the second non-volatile storage array is an array based on the second storage cores in the non-volatile storage chip.

In some possible implementations, at least part of the computing cores in the first chip constitutes a first array, at least part of the first storage cores in the volatile storage chip constitutes a second volatile storage array, and at least part of the second storage cores in the non-volatile storage chip constitutes a second non-volatile storage array;

in the case where the storage chip group comprises at least one non-volatile storage chip and at least one volatile storage chip arranged in a stacked manner, the computing cores in the first array, the first storage cores in the second volatile storage array, and the second storage cores in the second non-volatile storage array have a corresponding relationship, and the computing cores and the first storage cores as well as the first storage cores and the second storage cores with the corresponding relationship are connected;

in the case where the storage chip group comprises a plurality of volatile storage chips arranged in a stacked manner, there is a corresponding relationship between the computing cores in the first array and the first storage cores in the second volatile storage array, and between the first storage cores in different second volatile storage arrays, and the computing cores and the first storage cores as well as the first storage cores in different second volatile storage arrays with the corresponding relationship are connected;

in the case where the storage chip group comprises a plurality of non-volatile storage chips arranged in a stacked manner, there is a corresponding relationship between the computing cores in the first array and the second storage cores in the second non-volatile storage array, and between the second storage cores in different second non-volatile storage arrays, and the computing cores and the second storage cores as well as the second storage cores in different second non-volatile storage arrays with the corresponding relationship are connected.

It should be noted that for the first storage core (i.e., the storage core in the volatile storage chip), it can be used as a cache for the corresponding computing core and/or the second storage core (i.e., the storage core in the non-volatile storage chip), and for the second storage core, it can be used as an external storage for the corresponding computing core or the first storage core. External storage refers to the storage space that is relatively independent and private compared to the storage space in the core.

In some possible implementations, the corresponding relationship between the computing cores and the storage cores includes any one or more of one-to-one correspondence, one-to-many correspondence, and many-to-one correspondence. The corresponding relationship between the storage cores of different second volatile storage arrays also includes any one or more of one-to-one correspondence, one-to-many correspondence, and many-to-one correspondence. The corresponding relationship between the storage cores of different second non-volatile storage arrays also includes any one or more of one-to-one correspondence, one-to-many correspondence, and many-to-one correspondence. Based on this, the sizes of the first array, the second volatile storage array, and the second non-volatile storage array can be the same or different; the sizes of different second volatile storage arrays can be the same or different, and the sizes of different second non-volatile storage arrays can be the same or different. The embodiments of the present disclosure do not limit the number, size, and size relationship of the first array, the second volatile storage array, and the second non-volatile storage array.

In one example, the storage chip group comprises at least one non-volatile storage chip and at least one volatile storage chip arranged in a stacked manner. When the many-core processing apparatus needs to process tasks based on a large amount of cache space, the number of volatile storage chips and/or the number of storage cores in each volatile storage chip can be appropriately increased (using volatile storage as cache). Based on this, the number of the second volatile storage arrays may be large, and/or the size of the second volatile storage array may be larger than the size of the first array and the size of the second non-volatile storage array, thereby generating a situation where one computing core corresponds to multiple first storage cores, and multiple first storage cores correspond to one second storage core. Similarly, when the many-core processing apparatus requires much more computing power than storage, the number of computing cores may be appropriately increased. Based on this, the size of the first array may be larger than the size of the second volatile storage array and the second non-volatile storage array, thereby generating a situation where multiple computing cores correspond to multiple first storage cores, and multiple computing cores correspond to one second storage core.

It should be noted that no matter what type or number of second chips the storage chip group uses, and no matter what corresponding relationship there is between the computing cores and the storage cores, the first array is composed of computing cores which have data processing function, and the second array (including the second volatile storage array and the second non-volatile storage array) is composed of storage cores which have storage function. For the computing cores and storage cores having a corresponding relationship, the storage cores can provide information storage support for the computing cores, and the computing cores can perform data processing on the information in the storage cores, thereby realizing the organic combination of data processing function and storage function (including cache and/or external storage), which are configured together to perform the tasks of the many-core processing apparatus.

In summary, in some possible implementations, the corresponding relationship between the computing cores and the storage cores includes any one or more of one-to-one correspondence, one-to-many correspondence, and many-to-one correspondence. Based on this, the size of the first array and the size of the second array can be the same or different, and the embodiments of the present disclosure do not impose limitations on this aspect.

The many-core processing apparatus according to an embodiment of the present disclosure is described in detail below in conjunction with FIG. 6 to FIG. 9.

FIG. 6 is a schematic diagram of a many-core processing apparatus provided in an embodiment of the present disclosure. Referring to FIG. 6, six computing cores distributed in 2*3 are provided in the first chip, the first array is composed of the six computing cores, and each computing core communicates through an on-chip network; six storage cores distributed in 2*3 are provided in the second chip, and the second array is composed of the six storage cores.

In FIG. 6, the first array and the second array have the same size, and the computing cores in the first array and the storage cores in the second array have a one-to-one corresponding relationship, that is, one computing core is connected to one storage core.

FIG. 7 is a schematic diagram of a many-core processing apparatus provided by an embodiment of the present disclosure. Referring to FIG. 7, three computing cores distributed in 1*3 are provided in the first chip, the first array is composed of the three computing cores, and each computing core communicates through an on-chip network; six storage cores distributed in 2*3 are provided in the second chip, the second array is composed of the six storage cores, and there is a one-to-many corresponding relationship between the computing cores and the storage cores.

As shown in FIG. 7, the first array and the second array have different sizes, and the computing cores in a certain column in the first array have a corresponding relationship with the two storage cores in the same column in the second array. For example, the computing core in the first column has a corresponding relationship with the two storage cores in the first column, and the computing core is connected to the two storage cores respectively. Other columns are similar, which will not be described in detail here.

FIG. 8 is a schematic diagram of a many-core processing apparatus provided by an embodiment of the present disclosure. Referring to FIG. 8, the first chip is provided with six computing cores distributed in 2*3, the first array is composed of the six computing cores, and each computing core communicates through an on-chip network; the second chip is provided with three storage cores distributed in 1*3, the second array is composed of the three storage cores, and there is a many-to-one corresponding relationship between the computing cores and the storage cores.

As shown in FIG. 8, the sizes of the first array and the second array are different, and the storage cores in a certain column of the second array have a corresponding relationship with the two computing cores in the same column of the first array. For example, the storage core in the first column has a corresponding relationship with the two computing cores in the first column, and the storage core is connected to the two computing cores respectively. Other columns are similar, which will not be described in detail here.

FIG. 9 is a cross-sectional schematic diagram of a many-core processing apparatus provided by an embodiment of the present disclosure. Referring to FIG. 9, it shows a cross-sectional view of the many-core processing apparatus shown in FIG. 6. In FIG. 9, the first chip and the second chip are stacked face to face. In the first chip, each computing core communicates through its on-chip network, and the storage cores in the second chip establish connections with the corresponding computing cores by connecting to the corresponding routing nodes in the on-chip network.

The cross-sectional views of the many-core processing apparatuses shown in FIG. 7 and FIG. 8 are similar to FIG. 9 and will not be described in detail here.

As mentioned above, the storage core in any embodiment of the present disclosure is configured to provide storage resources. In some possible implementations, at least part of the storage cores includes a cache unit and/or a storage unit.

Exemplarily, at least part of the storage cores is provided with a storage unit, which has storage space and can be used to store data.

Exemplarily, at least part of the storage cores is provided with a cache unit, which can store data with a high access frequency to improve data reading and writing rate of the storage core.

In some possible implementations, the cache unit can adopt a volatile storage method, and the storage unit can adopt a volatile storage method and/or a non-volatile storage method. Wherein, the volatile storage method can adopt a Random Access Memory (RAM), etc., non-volatile storage can adopt Read-Only Memory (ROM) and/or Flash Memory, etc., and the embodiments of the present disclosure do not impose limitations on this aspect.

In one example, N storage cores are provided in the second chip/second array, the storage units of the N storage cores all use the volatile storage method or the non-volatile storage method, and N is an integer greater than or equal to 1.

In one example, N storage cores are provided in the second chip/second array, wherein storage units of n1 storage cores adopt the volatile storage method, storage units of n2 storage cores adopt a non-volatile storage method, n1, n2 are integers greater than or equal to 1, N is an integer greater than or equal to 2, and n1+n2=N.

In one example, the storage unit of at least one storage core in the second chip/second array adopts both a volatile storage method and a non-volatile storage method.

In some possible implementations, at least part of the storage cores is provided with a cache unit, and accordingly, the computing cores connected to this part of the storage cores can read data from the cache units by pre-reading.

It should be understood that when the data to be read by the computing core is not pre-stored in the cache unit, the computing core can read the corresponding data from the storage unit of the storage core.

In some possible implementations, the cache unit can adopt a volatile storage method, and the cache unit can be provided with a storage interface; at least part of the computing cores includes a first routing node, and can be connected to the storage interface of the corresponding storage core through the first routing node.

FIG. 10 is a schematic diagram of a many-core processing apparatus provided in an embodiment of the present disclosure. Referring to FIG. 10, the first chip is provided with six computing cores distributed in 2*3, the first array is composed of the six computing cores, each computing core has a first routing node, and the computing cores communicate with each other through an on-chip network composed of the first routing nodes and the corresponding link; the second chip is provided with six storage cores distributed in 2*3, the second array is composed of the six storage cores, and the storage core is provided with a cache unit.

Wherein, the computing cores and the storage cores have a one-to-one corresponding relationship, and the computing core is connected to the storage interface of the storage unit through the first routing node. Moreover, the computing core can read data from the cache unit by pre-reading.

In some possible implementations, the cache unit of the storage core adopts a Static Random-Access Memory (SRAM), the storage core and the computing core can be connected through a standard interface between SRAM and the first routing node, without the need for additional design or development of an interface, which simplifies the development and production cost of the chip.

It should be noted that when the computing core directly reads data from the storage core without a cache unit, the data transmission rate is usually at the nanosecond (ns) level, while when the computing core reads data from the SRAM-based cache unit, the data transmission rate can be increased to the picosecond (ps) level. It can be seen that providing a cache unit helps the computing core to quickly read data from the storage core, which further improves the data transmission rate compared to the storage core without a cache unit.

In some possible implementations, at least part of the storage cores is provided with a second routing node, and each second routing node is connected to each other, so that the storage cores can communicate with each other.

Correspondingly, in some possible implementations, the computing cores and the storage cores with a corresponding relationship can be connected by the respective first routing nodes and second routing nodes.

It should be noted that before the storage core of the second chip is provided with a second routing node, the computing cores can only transmit data through the routing network of the first chip (that is, the network formed by the first routing nodes). After the second routing node is added to the storage core of the second chip, the computing cores can also communicate in a circuitous manner by means of the connection between the first routing node and the second routing node and the connection between the second routing nodes, which expands the range of the communication path between the computing cores and increases the number of communication paths. Under normal circumstances, the computing core can transmit data to the destination computing core only based on the routing network of the first chip; when routing congestion occurs in the first chip, the computing core can transmit data to the destination computing core by means of the routing network of the second chip, thereby ensuring the smooth transmission of data and, at the same time, alleviating the routing congestion of the first chip to a certain extent.

FIG. 11 is a schematic diagram of a many-core processing apparatus provided by an embodiment of the present disclosure. Referring to FIG. 11, the first chip is provided with six computing cores distributed in 2*3, the first array is composed of the six computing cores, each computing core has a first routing node, and the computing cores communicate with each other through an on-chip network composed of the first routing nodes and the corresponding link; the second chip is provided with six storage cores distributed in 2*3, the second array is composed of the six storage cores, each storage core has a second routing node, and the storage cores can communicate with each other through the second routing nodes.

As shown in FIG. 11, the computing cores and the storage cores have a one-to-one corresponding relationship, and the computing core is connected to the second routing node of the storage core through the first routing node.

It should be understood that the computing cores can communicate directly through the first routing nodes, or can communicate in combination with the second routing nodes (for example, the first array has routing congestion), and the embodiment of the present disclosure does not limit this.

It should be noted that in the storage cores shown in FIG. 11, a cache unit (not shown) can also be provided, and the computing core can still read data from the cache unit by pre-reading. When the cache unit does not pre-store the data to be read, the corresponding data is read from the storage unit of the storage core.

In some possible implementations, a plurality of storage cores are connected through their respective second routing nodes to form a storage core cluster. In other words, in the second chip/the second array, some of the storage cores are connected through the second routing nodes to form a corresponding storage core cluster. In the second chip/the second array, there may be more than one storage core cluster.

In some possible implementations, a computing core connected to at least one storage core in the storage core cluster uses the storage resources of at least one storage core in the storage core cluster through the connection between the second routing nodes in the storage core cluster. That is, the computing core can share the storage resources of the storage core cluster, and the storage resources of the storage core cluster include the storage resources of all storage cores belonging to the storage core cluster.

FIG. 12 is a schematic diagram of a many-core processing apparatus provided by an embodiment of the present disclosure. Referring to FIG. 12, the first chip is provided with six computing cores distributed in 2*3, the first array is composed of the six computing cores, each computing core has a first routing node, and the computing cores communicate with each other through an on-chip network composed of the first routing nodes and the corresponding link; the second chip is provided with six storage cores distributed in 2*3, the second array is composed of the six storage cores, and each storage core has a second routing node, wherein the second routing nodes of the storage core 2-1 and storage core 2-2 are connected, and the storage core 2-1 and storage core 2-2 constitute a first storage core cluster; the second routing nodes of the storage core 2-3, storage core 2-4, storage core 2-5 and storage core 2-6 are connected, and the storage core 2-3, storage core 2-4, storage core 2-5 and storage core 2-6 constitute a second storage core cluster.

As shown in FIG. 12, the computing core 1-1 is connected to the second routing node of the storage core 2-1 through its first routing node, and the storage core 2-1 belongs to the first storage core cluster. Therefore, the computing core 1-1 can use the storage resources of the storage core 2-2 in the first storage core cluster in addition to the storage resources of the storage core 2-1. Similarly, the computing core 1-2 can use the storage resources of the storage core 2-1 in the first storage core cluster in addition to the storage resources of the storage core 2-2.

For computing cores 1-3 to 1-6, since they are connected to at least one storage core in the second storage core cluster, computing cores 1-3 to 1-6 can use the storage resources corresponding to storage cores 2-3 to 2-6.

In some possible implementations, the computing cores of the first chip include first routing nodes, and the computing cores are connected through the first routing nodes. The storage cores of the second chip stacked adjacent to the first chip include a second routing node, and the storage cores are connected through the second routing nodes; the computing cores and the storage cores are connected through the corresponding first routing nodes and second routing nodes.

FIG. 13 is a schematic diagram of a many-core processing apparatus provided in an embodiment of the present disclosure. Referring to FIG. 13, the many-core processing apparatus comprises a storage chip group formed by a plurality of second chips arranged in a stacked manner, and a first chip stacked with the storage chip group. Wherein, a general controller is provided in the second chip stacked adjacent to the first chip, and the general controller is connected to the storage cores in the second chip in which it is located and in other second chips.

As shown in FIG. 13, in the first chip, each computing core includes one first routing node; in the second chip stacked adjacent to the first chip, each storage core includes a second routing node. Each computing core is connected to the second routing node of the corresponding storage core through its first routing node, thereby realizing the connection between the computing core and the storage core.

In some possible implementations, the storage chip group includes at least one non-volatile storage chip and at least one volatile storage chip arranged in a stacked manner, at least one non-volatile storage chip is provided with a first general controller, at least one volatile storage chip is provided with a second general controller, and the first general controller is connected to the second general controller; the computing cores are connected to the storage cores in the non-volatile storage chip provided with the first general controller and/or the storage cores in the volatile storage chip provided with the second general controller.

In other words, the storage chip group can provide both non-volatile storage space and volatile storage space for the computing cores. The non-volatile storage space is uniformly controlled by the first general controller, and the volatile storage space is uniformly controlled by the second general controller. Moreover, through the connection between the first general controller and the second general controller, data can be orderly transmitted between the non-volatile storage chip, the volatile storage chip and the first chip.

In some possible implementations, when the storage chip group includes at least one non-volatile storage chip and at least one volatile storage chip arranged in a stacked manner, the storage space of the non-volatile storage chip is larger than the storage space of the volatile storage chip, and the storage space of the volatile storage chip is larger than the storage space of the first chip. Exemplarily, the non-volatile storage chip can provide storage space of 10 GB (gigabyte), the volatile storage chip can provide storage space of 10 MB (megabyte), and the computing core has a built-in storage space of 512 KB (kilobyte).

It can be seen that the computing core can use the storage core in the volatile storage chip as a cache and use the storage core in the non-volatile storage chip as an external storage. Moreover, usually, the external storage is larger than the cache, and the cache is larger than the storage space of the computing core itself. In some possible implementations, some data with a higher transmission frequency can be pre-stored in the volatile storage chip, and the computing core can read data from the storage core of the volatile storage chip by pre-reading or other methods, thereby increasing the data transmission rate.

In one example, the storage chip group includes one non-volatile storage chip and one volatile storage chip arranged in a stacked manner, the non-volatile storage chip is provided with a first general controller, the volatile storage chip is provided with a second general controller, the first general controller is connected to the second general controller, and the computing cores are connected to the storage cores in the volatile storage chip by a one-to-one corresponding relationship.

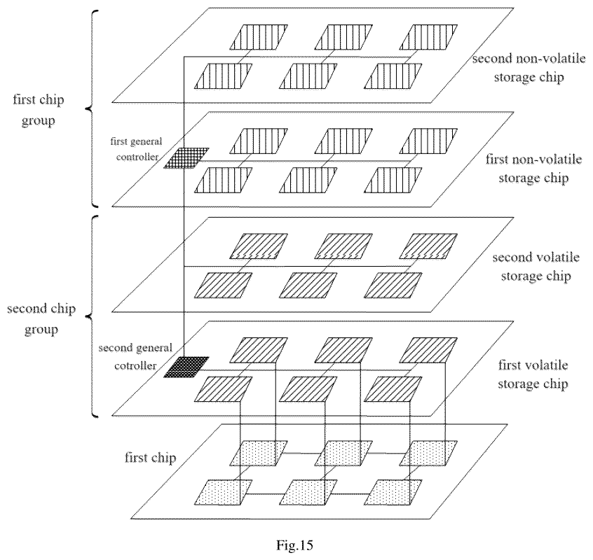

FIG. 14 is a schematic diagram of a many-core processing apparatus provided in an embodiment of the present disclosure. Referring to FIG. 14, the many-core processing apparatus includes one non-volatile storage chip, one volatile storage chip and a first chip stacked in sequence from top to bottom, wherein one non-volatile storage chip and one volatile storage chip constitute a storage chip group.

As shown in FIG. 14, the non-volatile storage chip includes six storage cores distributed in 2*3 and one first general controller, and the first general controller is connected to the six storage cores in the non-volatile storage chip; the volatile storage chip includes six storage cores distributed in 2*3 and one second general controller, and the second general controller is connected to the six storage cores in the volatile storage chip; the first chip includes six computing cores distributed in 2*3, and each computing core communicates with each other through an on-chip network. Wherein, the first general controller is connected to the second general controller, the computing cores have a one-to-one corresponding relationship with the storage cores in the volatile storage chip, and each computing core is connected to one storage core in the volatile storage chip.

It should be understood that FIG. 14 only shows the case where the computing core is directly connected to the storage core of the volatile storage chip. In other implementations, the computing core may also be directly connected to the storage core in the non-volatile storage chip, and the embodiment of the present disclosure does not limit this.

In one example, the storage chip group includes a plurality of non-volatile storage chips and a plurality of volatile storage chips arranged in a stacked manner, the plurality of non-volatile storage chips are stacked in sequence to form a first chip group, the plurality of volatile storage chips are stacked in sequence to form a second chip group, the first chip group, the second chip group and the first chip are stacked in sequence.

The first general controller corresponding to the first chip group is arranged on the non-volatile storage chip stacked adjacent to the volatile storage chip, and the first general controller is connected to the plurality of storage cores in the first chip group for controlling the plurality of connected storage cores.

The second general controller corresponding to the second chip group is arranged on the volatile storage chip stacked adjacent to the first chip, and the second general controller is connected to the plurality of storage cores in the second chip group for controlling the plurality of connected storage cores.

The computing cores are connected to the storage cores in the volatile storage chip stacked adjacent to the first chip.

FIG. 15 is a schematic diagram of a many-core processing apparatus provided in an embodiment of the present disclosure. Referring to FIG. 15, the many-core processing apparatus includes a first chip group, a second chip group, and a first chip stacked sequentially from top to bottom. The first chip group includes a first non-volatile storage chip and a second non-volatile storage chip, and the second chip group includes a first volatile storage chip and a second volatile storage chip.

As shown in FIG. 15, in the first chip group, each non-volatile storage chip includes six storage cores distributed in 2*3, and one first general controller is provided on the first non-volatile storage chip to control all storage cores in the first chip group; in the second chip group, each volatile storage chip includes six storage cores distributed in 2*3, and one second general controller is provided on the first volatile storage chip to control all storage cores in the second chip group; the first chip includes six computing cores distributed in 2*3, and each computing core communicates with each other through an on-chip network. The first general controller is connected to the second general controller, the computing cores and the storage cores in the first volatile storage chip have a one-to-one corresponding relationship, and each computing core is connected to one storage core in the first volatile storage chip.

In some possible implementations, the storage chip group includes at least one non-volatile storage chip and at least one volatile storage chip arranged in a stacked manner, a plurality of first sub-controllers are arranged in at least one non-volatile storage chip, and a plurality of second sub-controllers are arranged in at least one volatile storage chip.

The storage cores in the non-volatile storage chip have a corresponding relationship with the storage cores in the volatile storage chip, and the first sub-controllers and the second sub-controllers of the storage cores having the corresponding relationship are connected.

A processing unit is arranged in the computing core, the processing unit is connected to at least one first sub-controller and/or at least one second sub-controller to send data operation instructions to the connected first sub-controller and/or the second sub-controller, so that the first sub-controller and/or the second sub-controller can process data in the corresponding storage core based on the data operation instructions.

In some possible implementations, the processing unit is a small-scale Central Processing Unit (CPU), for example, the processing unit is a processor supporting Reduced Instruction Set Computer-five (RISC-V).

In some possible implementations, the processing unit is connected to the controller of the second chip, and by programming and command control of the processing unit, the function of controlling the data transfer inside the second chip or between the second chips by the processing unit can be realized.

In one example, the storage chip group includes one non-volatile storage chip and one volatile storage chip arranged in a stacked manner; each storage core in the non-volatile storage chip includes one first sub-controller, and each storage core in the volatile storage chip includes one second sub-controller; in the first chip, each computing core includes a processing unit.

Each computing core has a corresponding relationship with at least one storage core in the volatile storage chip and at least one storage core in the non-volatile storage chip, and at least one storage core in the volatile storage chip has a corresponding relationship with at least one storage core in the non-volatile storage chip. Accordingly, the processing units of the computing cores with the corresponding relationship are connected to the first sub-controllers/the second sub-controllers of the corresponding storage cores, and the first sub-controller and the second sub-controller of the storage cores with the corresponding relationship are connected.

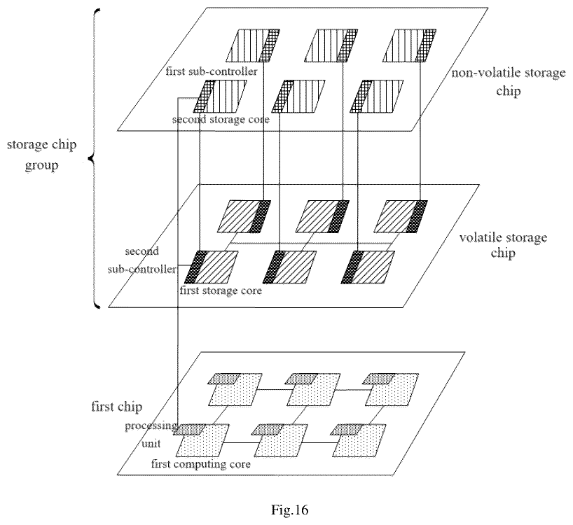

FIG. 16 is a schematic diagram of a many-core processing apparatus provided in an embodiment of the present disclosure. Referring to FIG. 16, the many-core processing apparatus includes one non-volatile storage chip, one volatile storage chip and a first chip stacked in sequence from top to bottom, wherein one non-volatile storage chip and one volatile storage chip constitute a storage chip group.

As shown in FIG. 16, the non-volatile storage chip includes six storage cores distributed in 2*3, each storage core includes one first sub-controller; the volatile storage chip includes six storage cores distributed in 2*3, respective storage cores are connected to each other, and each storage core includes one second sub-controller; the first chip includes six computing cores distributed in 2*3, each computing core includes one processing unit, and each computing core communicates through an on-chip network. There is a one-to-one corresponding relationship between the computing cores, the storage cores in the volatile storage chip, and the storage cores in the non-volatile storage chip, that is, any storage core in the non-volatile storage chip is connected to a storage core in the volatile storage chip, and there is a processing unit of a computing core in the first chip that is connected to the first sub-controller and the second sub-controller corresponding to the above two storage cores.

In order to avoid too many connections, FIG. 16 only shows the connection relationship between the processing unit of the first computing core and the corresponding first sub-controller and second sub-controller. Taking the first computing core as an example, there is a one-to-one corresponding relationship between the first computing core, the first storage core in the volatile storage chip, and the second storage core in the non-volatile storage chip. Therefore, the processing unit of the first computing core is connected to the second sub-controller of the first storage core and the first sub-controller of the second storage core, and the second sub-controller of the first storage core is also connected to the first sub-controller of the second storage core. Other computing cores are similar and will not be described in detail here.

In some possible implementations, the six storage cores in the non-volatile storage chip can also be interconnected. In this case, any first sub-controller can control all storage cores in the non-volatile storage chip.

It should be noted that in FIG. 16, the first sub-controller and the second sub-controller of some storage cores are arranged in the upper left corner of the storage core, and the first sub-controller and the second sub-controller of some storage cores are arranged in the upper right corner of the storage core. This is only for the convenience of showing the connection relationship between the various units in the many-core processing apparatus, and is not used to limit the packaging position of the first sub-controller and the second sub-controller in the storage core.

In some possible implementations, the storage chip group includes a plurality of non-volatile storage chips and a plurality of volatile storage chips arranged in a stacked manner, the plurality of non-volatile storage chips are stacked in sequence to form a third chip group, the plurality of volatile storage chips are stacked in sequence to form a fourth chip group, the third chip group, the fourth chip group and the first chip are stacked in sequence.

The storage cores in the non-volatile storage chip stacked adjacent to the volatile storage chip have a corresponding relationship with at least one storage core in other non-volatile storage chips in the third chip group, the storage cores with the corresponding relationship constitute a first storage core cluster, and at least part of the first storage core clusters is connected to the first sub-controller (for example, each first storage core cluster is connected to one first sub-controller), and the first sub-controller is provided in the non-volatile storage chip stacked adjacent to the volatile storage chip.

The storage cores in the volatile storage chip stacked adjacent to the first chip have a corresponding relationship with at least one storage core in other volatile storage chips in the fourth chip group, and the storage cores with the corresponding relationship constitute a second storage core cluster, at least part of the second storage core clusters is connected to the second sub-controller (for example, each second storage core cluster can be connected to one second sub-controller), and the second sub-controller is provided in the volatile storage chip stacked adjacent to the first chip.

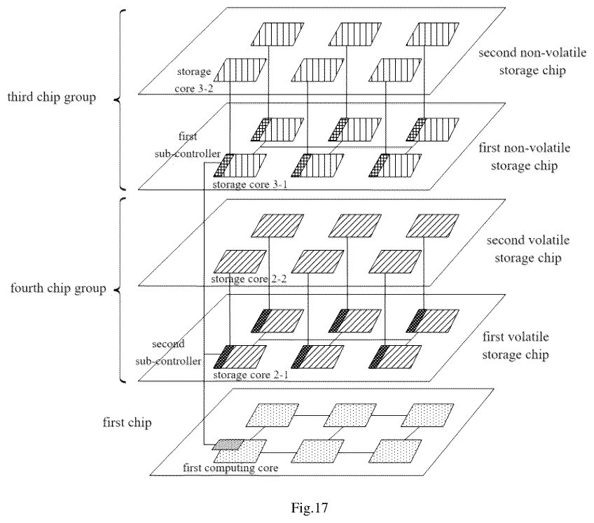

FIG. 17 is a schematic diagram of a many-core processing apparatus provided by an embodiment of the present disclosure. Referring to FIG. 17, the many-core processing apparatus includes a third chip group, a fourth chip group and a first chip stacked in sequence from top to bottom. Wherein, the third chip group includes two non-volatile storage chips, namely, first volatile storage chip and second volatile storage chip, and the fourth chip group includes two volatile storage chips, namely, first non-volatile storage chip and second non-volatile storage chip.

As shown in FIG. 17, in the third chip group, each non-volatile storage chip includes six storage cores distributed in 2*3, wherein the storage cores in the second non-volatile storage chip are connected, each storage core includes a first sub-controller, and the storage cores of the second non-volatile storage chip are not connected to each other and a first sub-controller is not provided; in the fourth chip grouping, each volatile storage chip includes six storage cores distributed in 2*3, wherein the storage cores in the first volatile storage chip are connected, each storage core includes a second sub-controller, and the storage cores of the second volatile storage chip are not connected to each other and a second sub-controller is not provided; the first chip includes six computing cores distributed in 2*3, and each computing core communicates with each other through the on-chip network.

In order to avoid too many connection wires affecting the display effect, FIG. 17 only shows the connection relationship between the processing unit of the first computing core and the corresponding first sub-controller and second sub-controller. The storage core 3-1 in the first non-volatile storage chip has a corresponding relationship with the storage core 3-2 in the second non-volatile storage chip, and they constitute a first storage core cluster; the first sub-controller in the storage core 3-1 is connected to the storage core 3-2, and the first sub-controller can control the storage core 3-1 and the storage core 3-2. Similarly, the storage core 2-1 in the first volatile storage chip has a corresponding relationship with the storage core 2-2 in the second volatile storage chip, and they constitute a second storage core cluster; the second sub-controller in the storage core 2-1 is connected to the storage core 2-2, and the second sub-controller can control the storage core 2-1 and the storage core 2-2. The first computing core has a corresponding relationship with the above-mentioned first storage core cluster and second storage core cluster. Therefore, the processing unit of the first computing core is connected to the first sub-controller and the second sub-controller respectively, so that the first computing core can use the storage resources of the first storage core cluster and the second storage core cluster, wherein the first storage core cluster provides external storage resources and the second storage core cluster provides cache resources.

It should be noted that FIG. 17 only shows a one-to-one corresponding connection relationship. In actual applications, the storage core 3-1 can constitute a first storage core cluster with a plurality of storage cores in the second non-volatile storage chip, and the storage core 2-1 can also constitute a second storage core cluster with a plurality of storage cores in the second volatile storage chip. Correspondingly, the computing core can correspond to a plurality of first storage core clusters or a plurality of second storage core clusters at the same time, and the embodiments of the present disclosure are not limited to this.

In some possible implementations, the storage chip group includes a plurality of volatile storage chips arranged in a stacked manner, a third general controller is provided in the volatile storage chip stacked adjacent to the first chip, the third general controller is configured to control all storage cores in the storage chip group, and the computing cores in the first chip are connected to the storage cores in the volatile storage chip stacked adjacent to the first chip.

In some possible implementations, when the storage chip group includes a plurality of volatile storage chips arranged in a stacked manner, the storage space of the volatile storage chip is larger than the storage space of the first chip. The storage space of the first chip is composed of independent storage space of the plurality of computing cores.

In some possible implementations, the storage chip group includes a plurality of non-volatile storage chips arranged in a stacked manner, a fourth general controller is provided in the non-volatile storage chip stacked adjacent to the first chip, the fourth general controller is configured to control all storage cores in the storage chip group, and the computing cores in the first chip are connected to the storage cores in the non-volatile storage chip stacked adjacent to the first chip.

In some possible implementations, when the storage chip group includes a plurality of non-volatile storage chips arranged in a stacked manner, the storage space of the non-volatile storage chip is larger than the storage space of the first chip. Wherein, the storage space of the first chip is composed of independent storage space of the plurality of computing cores.

It can be seen from this that the storage chip group can be composed of a second chip with single storage function, and a general controller controls all storage cores in the storage chip group. For example, when the storage chip group is composed of volatile storage chips, it can only provide volatile storage function for the computing cores, and each storage core is controlled by the third general controller; when the storage chip group is composed of non-volatile storage chips, it can only provide single non-volatile storage function for the computing cores, and each storage core is controlled by the fourth general controller.

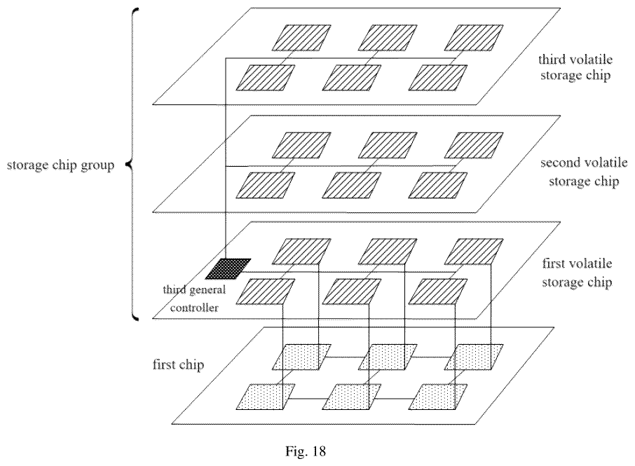

FIG. 18 is a schematic diagram of a many-core processing apparatus provided by an embodiment of the present disclosure. Referring to FIG. 18, the many-core processing apparatus includes a storage chip group and a first chip stacked in sequence from top to bottom. Wherein, the storage chip group includes three volatile storage chips, namely, first volatile storage chip, second volatile storage chip and third volatile storage chip.

As shown in FIG. 18, each volatile storage chip includes six storage cores distributed in 2*3, and a third general controller is provided in the first volatile storage chip. The third general controller is not only connected to the six storage cores in the first volatile storage chip, but also connected to all the storage cores in the second volatile storage chip and the third volatile storage chip. All the storage cores in the storage chip group are within the control range of the third general controller. The first chip includes six computing cores distributed in 2*3, and each computing core communicates with each other through an on-chip network, and each computing core is connected to a storage core in the first volatile storage chip.

As described above, a storage chip group with single storage function can be controlled by a general controller. This control method is convenient for global control, but the flexibility is not high. Therefore, in order to improve the flexibility of control, for a storage chip group with single storage function, a plurality of sub-controllers can be provided, and each sub-controller controls some of the storage cores, so as to control the storage cores more flexibly and diversely.

In some possible implementations, the storage chip group includes a plurality of volatile storage chips arranged in a stacked manner, storage cores of the volatile storage chip stacked adjacent to the first chip have a corresponding relationship with at least one storage core in other volatile storage chips in the storage chip group, and the storage cores with the corresponding relationship constitute a third storage core cluster, at least part of the third storage core clusters is connected to the third sub-controller (for example, each third storage core cluster is connected to one third sub-controller), the third sub-controller is provided on the volatile storage chip stacked adjacent to the first chip, and the computing cores in the first chip are connected to the storage cores in the volatile storage chip stacked adjacent to the first chip.

In some possible implementations, the storage chip group includes a plurality of non-volatile storage chips arranged in a stacked manner, storage cores of the non-volatile storage chip stacked adjacent to the first chip have a corresponding relationship with at least one storage core in other non-volatile storage chips in the storage chip group, and the storage cores with the corresponding relationship constitute a fourth storage core cluster, at least part of the fourth storage core clusters is connected to the fourth sub-controller (for example, each fourth storage core cluster is connected to one fourth sub-controller), the fourth sub-controller is arranged on the non-volatile storage chip stacked adjacent to the first chip, and the computing cores in the first chip are connected to the storage cores in the non-volatile storage chip stacked adjacent to the first chip.

It can be seen that by forming a storage core cluster with a plurality of storage cores with a corresponding relationship in different second chips, the computing core can not only use the storage resources of the storage core directly connected to it, but also use the storage resources of the storage core cluster where the storage core is located.

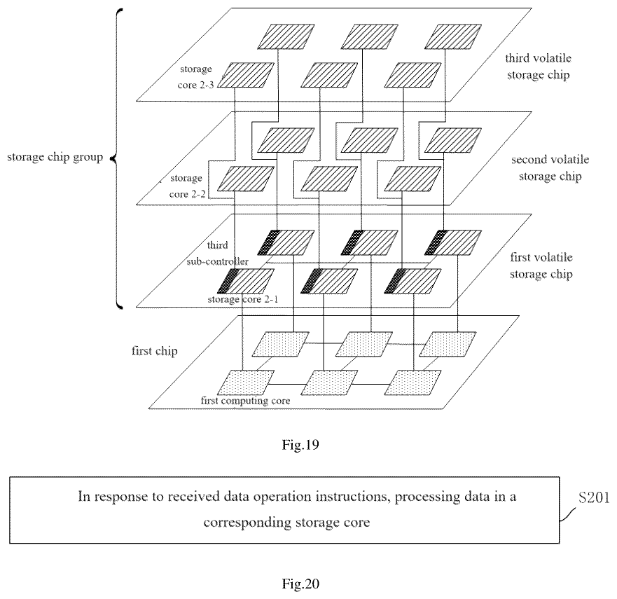

FIG. 19 is a schematic diagram of a many-core processing apparatus provided by an embodiment of the present disclosure. Referring to FIG. 19, the many-core processing apparatus includes a storage chip group and a first chip stacked in sequence from top to bottom. Wherein, the storage chip group includes three volatile storage chips, namely, first volatile storage chip, second volatile storage chip and third volatile storage chip, and each volatile storage chip includes six storage cores distributed in 2*3. Moreover, the storage cores in the first volatile storage chip are connected, and each storage core includes a third sub-controller; the storage cores in the second volatile storage chip are not connected, and no third sub-controller is provided; the storage cores in the third volatile storage chip are not connected, and no third sub-controller is provided. The first chip includes six computing cores distributed in 2*3, each computing core communicates through an on-chip network, and each computing core is connected to a storage core in the first volatile storage chip.

As shown in FIG. 19, each storage core of the first volatile storage chip has a corresponding relationship with a storage core in the second volatile storage chip and a storage core in the third volatile storage chip, respectively, the three form a third storage core cluster and are respectively connected to the corresponding third sub-controller. Taking the first computing core as an example for illustrative description, the first computing core is connected to the storage core 2-1, the storage core 2-1, storage core 2-2 and storage core 2-3 form the third storage core cluster, and the storage core 2-2 and storage core 2-3 are both connected to the third sub-controller in storage core 2-1. Other computing cores are similar and will not be described in detail here.

In the second aspect, an embodiment of the present disclosure provides a data processing method.

The data processing method according to the embodiment of the present disclosure can be applied to the many-core processing apparatus described in any one of the embodiments of the present disclosure. The many-core processing apparatus comprises a first chip and at least one second chip arranged in a stacked manner, the first chip comprises a plurality of computing cores, the at least one second chip forms a storage chip group, the second chip comprises a plurality of storage cores, and at least one computing core in the first chip is connected to at least one storage core in the storage chip group.

FIG. 20 is a flow chart of a data processing method provided by an embodiment of the present disclosure. Referring to FIG. 20, the data processing method comprises:

in step S201, in response to received data operation instructions, processing data in the corresponding storage cores.

In some possible implementations, the data operation instruction is an instruction received by the many-core processing apparatus during the processing of a target task.

In some possible implementations, the target task includes any one of an image processing task, a speech processing task, a text processing task, and a video processing task, and the embodiment of the present disclosure does not limit the specific type of the target task.

In some possible implementations, the data operation instruction can be sent by an external device to a computing core of the many-core processing apparatus, and the corresponding storage core includes a storage core connected to the computing core.

In some possible implementations, the data operation instruction includes a data read instruction and/or a data write instruction, the data read instruction is used to instruct the computing core to read data from the storage core connected to the computing core, and the data write instruction is used to instruct the computing core to write data to the storage core connected to the computing core.

In other words, the computing core can read data from the connected storage core or write data to the connected storage core. In some possible implementations, the data read by the computing core from the storage core include configuration data, data written to the storage core by other writing devices, etc., and the data written by the computing core to the storage core include intermediate data and result data generated by the current computing core during task processing, etc., which are not limited in the embodiments of the present disclosure.

In some possible implementations, a storage unit is provided in the storage core, and the computing core reads or writes data from or to the storage unit of the connected storage core in response to the data operation instructions.

In some possible implementations, a cache unit is provided in the storage core, and the computing core reads or writes data from or to the cache unit of the connected storage core in response to the data operation instructions, and reads the corresponding data from the storage unit of the storage core when the data to be read is not stored in the cache unit.

In some possible implementations, a second routing node is provided in the storage core, each second routing node is connected so that the storage cores can communicate with each other, and the computing cores and storage cores with corresponding relationship can be connected through their respective first routing nodes and second routing nodes.

It should be noted that before the storage core of the second chip is provided with a second routing node, the computing cores can only transmit data through the routing network of the first chip (i.e., the network formed by the first routing nodes). After the second routing node is added to the storage core of the second chip, the computing cores can also communicate in a circuitous manner with the help of the connection between the first routing node and the second routing node and the connection between the second routing nodes, which expands the range of the communication path between the computing cores and increases the number of communication paths. Under normal circumstances, the computing core can transmit data to the destination computing core only based on the routing network of the first chip; when the first chip has routing congestion, the computing core can transmit data to the destination computing core with the help of the routing network of the second chip, thereby ensuring the smooth transmission of data, and at the same time, it can also alleviate the routing congestion of the first chip to a certain extent.

In some possible implementations, in the second array, a plurality of storage cores are connected through their respective second routing nodes to form a storage core cluster. The computing core connected to at least one storage core in the storage core cluster responds to the data operation instruction and reads or writes data from or to at least one storage core in the storage core cluster through the connection between the second routing nodes in the storage core cluster.

It can be seen that in step S201, the storage cores connected to the computing core are not limited to the storage core directly connected to the computing core, but also comprise the storage cores indirectly connected to the computing core through the second routing nodes (that is, other storage cores in the same storage core cluster as the directly connected storage core).

In some possible implementations, in the case where the many-core processing apparatus includes a controller, the data operation instruction can be an instruction sent by the computing core to the controller.

In some possible implementations, the computing core includes a processing unit, and accordingly, the data operation instruction is sent by the processing unit connected to the controller to instruct the controller to read data from the corresponding storage core, and/or write data to the corresponding storage core.

Exemplarily, the data operation instruction includes a data read instruction and/or a data write instruction, the data read instruction is used to instruct the controller to read data from the corresponding storage core, and the data write instruction is used to instruct the controller to write data to the corresponding storage core. Wherein, the data read from the storage core can be further transmitted to the corresponding computing core or storage core, and similarly, the data written to the storage core can be the data read from the computing core or other storage cores.

In other words, under the action of the data operation instruction of the controller, the computing core can read data from the corresponding storage core, and can also write data to the corresponding storage core, and the storage cores can also read and write data therebetween. It can be seen that the function of whether a data read instruction or a data write instruction is to realize the data transmission inside the second chip, between the second chips, between the second chip and the first chip, and even between the many-core processing apparatus and an external electronic device.

In some possible implementations, the data that can be read from the storage core include configuration data, and data written to the storage core by other writing devices, etc., and the data that can be written to the storage core include data generated by the computing core during the task processing (including intermediate data, result data, etc.) and data in other storage cores, etc. The data transmitted between the storage cores include but are not limited to the above-mentioned types of data, and the embodiments of the present disclosure are not limited to this.

In some possible implementations, data operation instructions are instructions received or generated by the many-core processing apparatus in the process of processing a target task and further forwarded to the controller, wherein the target task includes any one of an image processing task, a speech processing task, a text processing task, and a video processing task. The embodiments of the present disclosure do not limit the specific type of the target task.

In one example, the first chip of the many-core processing apparatus includes a plurality of computing cores, and each computing core is provided with a processing unit, which sends data operation instructions to a controller connected thereto.

In some possible implementations, the processing unit is a small-scale central processing unit. For example, the processing unit is a processor that supports Reduced Instruction Set Computer-five, and the processing unit sends data operation instructions to the corresponding controller. After receiving the data operation instructions, the controller compiles the data operation instructions and performs corresponding data transmission operation according to the compilation result.

In some possible implementations, the storage chip group includes at least one non-volatile storage chip and/or at least one volatile storage chip arranged in a stacked manner, or the storage chip group includes a plurality of volatile storage chips arranged in a stacked manner, or the storage chip group includes a plurality of non-volatile storage chips arranged in a stacked manner.

In the case where the storage chip group includes at least one non-volatile storage chip and at least one volatile storage chip arranged in a stacked manner, the data operation instructions are configured to transmit data between the non-volatile storage chip and the volatile storage chip, between the non-volatile storage chip and the first chip, and between the volatile storage chip and the first chip.

In the case where the storage chip group includes a plurality of volatile storage chips arranged in a stacked manner, the data operation instructions are configured to transmit data between the volatile storage chips, and between the volatile storage chip and the first chip.

In the case where the storage chip group includes a plurality of non-volatile storage chips arranged in a stacked manner, the data operation instructions are configured to transmit data between the non-volatile storage chips, and between the non-volatile storage chip and the first chip.

Taking the many-core processing apparatus shown in FIG. 14 as an example, in FIG. 14, the first general controller can control the read and write operations of each storage core in the non-volatile storage chip, and the first general controller can also read or write data from or to the storage core in the volatile storage chip through the second general controller, and read or write data from or to the corresponding computing core. The second general controller is similar to the first general controller, which can control the read and write operations of each storage core in the volatile storage chip, and the second general controller can also read or write data from or to the storage core of the non-volatile storage chip through the first general controller, and read or write data from or to the corresponding computing core. It can be seen that through the control of the first general controller and the second general controller, data can be transmitted inside the non-volatile storage chip, inside the volatile storage chip, between the non-volatile storage chip and the volatile storage chip, between the non-volatile storage chip and the first chip, and between the volatile storage chip and the first chip. This data transmission is reflected in the functional level, which is equivalent to providing the computing core with cache function based on volatile storage and external storage function based on non-volatile storage, so that the computing core can obtain disposable storage resources from the outside when its own storage is limited.

Compared with FIG. 14, the many-core processing apparatus shown in FIG. 15 is equivalent to expanding external volatile storage resources and non-volatile storage resources. On this basis, data can be transmitted within the non-volatile storage chip, between non-volatile storage chips, within the volatile storage chip, between volatile storage chips, between the non-volatile storage chip and the volatile storage chip, between the non-volatile storage chip and the first chip, and between the volatile storage chip and the first chip through the control function across the second chips by the first general controller and the second general controller. The essence of the data processing method is the same as the data processing method corresponding to FIG. 14, and will not be described in detail here.

For a many-core processing apparatus with a sub-controller, it can process data for finer-grained storage resources or preset local storage resources (for example, a storage core cluster), which is relatively more flexible, but the essence of the data processing method remains unchanged and will not be described here.

According to the data processing method provided in the embodiment of the present disclosure, it is possible to transmit data between the computing cores and the storage cores in the stacked first chip and at least one second chip at high speed, including the computing core reading data from the storage core connected thereto, and the computing core writing data to the storage core connected thereto.

It can be understood that the above-mentioned embodiments of various method in the present disclosure can be combined with each other to form a combined embodiment without violating the principle and logic. Due to space limitations, the present disclosure will not make a description in detail. Those skilled in the art can understand that in the above-mentioned methods of the specific implementations, the specific execution order of each step should be determined by its function and possible internal logic.

In addition, the present disclosure also provides an electronic device and a computer-readable storage medium, which can be implemented based on any many-core processing apparatus provided by the present disclosure, and the corresponding technical scheme and description can refer to the corresponding record of the apparatus, which will not be repeated.

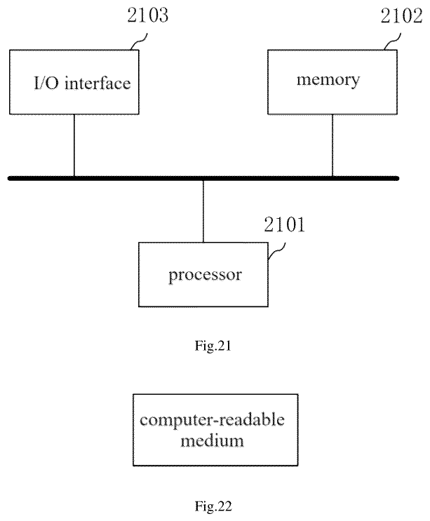

FIG. 21 is a block diagram of an electronic device provided by an embodiment of the present disclosure.

Referring to FIG. 21, an embodiment of the present disclosure provides an electronic device, which includes: at least one processor 2101; at least one memory 2102, and one or more I/O interfaces 2103, connected between the processor 2101 and the memory 2102: wherein the memory 2102 stores one or more computer programs that can be executed by at least one processor 2101, and the one or more computer programs are executed by at least one processor 2101, so that at least one processor 2101 can perform the above-mentioned data processing method.

The embodiment of the present disclosure also provides a computer-readable storage medium, on which a computer program is stored.

FIG. 22 is a composition block diagram of a computer-readable medium provided by an embodiment of the present disclosure. The computer program implements the above-mentioned data processing method when executed by a processor/processing core. The computer-readable storage medium may be a volatile or non-volatile computer-readable storage medium.

The embodiment of the present disclosure also provides a computer program product, including computer-readable code, or a non-volatile computer-readable storage medium carrying computer-readable code, when the computer-readable code is executed in the processor of the electronic device, the processor in the electronic device performs the above-mentioned data processing method.

It will be appreciated by those skilled in the art that all or some of the steps, systems, and functional modules/units in the method disclosed above may be implemented as software, firmware, hardware, and appropriate combinations thereof. In hardware implementations, the division of the functional module/units mentioned in the above description does not necessarily correspond to the division of physical components; for example, a physical component may have multiple functions, or function or a step may be performed by several physical components in cooperation. Some physical components or all physical components may be implemented as software executed by a processor, such as a central processing unit, a digital signal processor or a microprocessor, or implemented as hardware, or implemented as an integrated circuit, such as an application-specific integrated circuit. Such software may be distributed on a computer-readable storage medium, which may include a computer storage medium (or non-volatile medium) and a communication medium (or volatile medium).

As known to those skilled in the art, the term of computer storage medium includes volatile and non-volatile, removable and non-removable media implemented in any method or technology for storing information (such as computer-readable program instructions, data structures, program modules, or other data). Computer storage media include, but are not limited to, random access memory (RAM), read-only memory (ROM), erasable programmable read-only memory (EPROM), static random access memory (SRAM), flash memory or other memory technology, portable compact disk read-only memory (CD-ROM), digital versatile disk (DVD) or other optical disk storage, magnetic cassettes, magnetic tapes, magnetic disk storage or other magnetic storage devices, or any other medium that can be used to store desired information and can be accessed by a computer. In addition, it is well known to those of ordinary skill in the art that communication media generally comprise computer-readable program instructions, data structures, program modules, or other data in modulated data signals such as carrier waves or other transmission mechanisms, and may comprise any information delivery medium.

The computer-readable program instructions described herein can be downloaded from a computer-readable storage medium to various computing/processing devices, or downloaded to an external computer or external storage device via a network, such as the Internet, a local area network, a wide area network and/or a wireless network. The network can include copper transmission cables, optical fiber transmission, wireless transmission, a router, a firewall, a switch, a gateway computer and/or an edge server. The network adapter card or network interface in each computing/processing device receives computer-readable program instructions from the network, and forwards the computer-readable program instructions for storage in the computer-readable storage medium in each computing/processing device.

The computer program instructions for performing the disclosed operation can be assembly instructions, instruction set architecture (ISA) instructions, machine instructions, machine-related instructions, microcode, firmware instructions, state configuration data, or source code or object code written in any combination of one or more programming languages, including object-oriented programming languages, such as Smalltalk, C++, etc., and conventional procedural programming languages, such as “C” language or similar programming languages. The computer-readable program instructions can be executed completely on the user's computer, partially on the user's computer, as an independent software package, partially on the user's computer and partially on the remote computer, or completely on the remote computer or server. In the case where a remote computer is involved, the remote computer can be connected to the user's computer through any type of network, including a local area network (LAN) or a wide area network (WAN), or can be connected to an external computer (for example, using an Internet service provider to connect through the Internet). In some embodiments, an electronic circuit, such as a programmable logic circuit, a field programmable gate array (FPGA) or a programmable logic array (PLA), is personalized by using the state information of the computer-readable program instructions, and the electronic circuit can execute the computer-readable program instructions to implement various aspects of the present disclosure.

The computer program product described here can be implemented by hardware, software or a combination thereof. In an optional embodiment, the computer program product is embodied as a computer storage medium, and in another optional embodiment, the computer program product is embodied as a software product, such as a Software Development Kit (SDK) and the like.

Various aspects of the present disclosure are described herein with reference to the flowcharts and/or block diagrams of the methods, devices (systems) and computer program products according to the embodiments of the present disclosure. It should be understood that each box of the flowchart and/or the block diagram and the combination of boxes in the flowchart and/or block diagram can be implemented by computer-readable program instructions.

These computer-readable program instructions can be provided to a processor of a general-purpose computer, a special-purpose computer or other programmable data processing device, thereby producing a machine so that when these instructions are executed by the processor of a computer or other programmable data processing device, the functions/actions specified in one or more boxes in the flowchart and/or block diagram are generated. These computer-readable program instructions can also be stored in a computer-readable storage medium, which enables a computer, a programmable data processing device, or other equipment to work in a specific manner, so that the computer-readable medium storing the instructions includes a product of manufacture, which includes instructions for implementing various aspects of the functions/actions specified in one or more boxes in the flowchart and/or block diagram.

Computer-readable program instructions can also be loaded to a computer, other programmable data processing device, or other device, so that a series of operating steps are performed on the computer, other programmable data processing device, or other device to produce a computer-implemented process, so that the instructions executed on the computer, other programmable data processing device, or other device implement the functions/actions specified in one or more boxes in the flowchart and/or block diagram.

The flowcharts and block diagrams in the accompanying drawings show the possible implementation architecture, functions, and operations of the system, method, and computer program product according to several embodiments of the present disclosure. In this regard, each box in the flowchart or block diagram can represent a module, a program segment, or a part of an instruction, and a module, a program segment, or a part of an instruction contains one or more executable instructions for implementing a specified logical function. In some alternative implementations, the functions marked in the box can also occur in an order different from that marked in the accompanying drawings. For example, two consecutive boxes can actually be executed substantially in parallel, and they can sometimes be executed in the opposite order, depending on the involved function. It should also be noted that each box in the block diagram and/or the flowchart, and the combination of the boxes in the block diagram and/or the flowchart, can be implemented with a dedicated hardware-based system that performs the specified function or action, or can be implemented with a combination of dedicated hardware and computer instructions.

Exemplary embodiments have been disclosed herein, and although terms are used, they are only used and should only be interpreted as general illustrative meanings, and are not used for limiting purposes. In some examples, it is obvious to those skilled in the art that, unless otherwise explicitly stated, the features, characteristics and/or elements described in conjunction with a specific embodiment can be used alone or be used in combination with the features, characteristics and/or elements described in conjunction with other embodiments. Therefore, it will be understood by those skilled in the art that various changes in form and detail can be made without departing from the scope of the present disclosure as set forth in the appended claims.

1. A many-core processing apparatus, comprising:
a first chip and at least one second chip arranged in a stacked manner, the first chip comprises a plurality of computing cores, the at least one second chip forms a storage chip group, and the second chip comprises a plurality of storage cores;
at least one computing core in the first chip is connected to at least one storage core in the storage chip group.

2. The many-core processing apparatus according to claim 1, wherein the first chip and the storage chip group, as well as the plurality of second chips in the storage chip group adopt a face-to-face stacking manner and/or a sequential stacking manner.

3. The many-core processing apparatus according to claim 1, wherein at least part of the computing cores in the first chip forms a first array, and at least part of the storage cores in the second chip forms a second array;
the computing cores in the first array have a corresponding relationship with the storage cores in the second array, and the computing cores and the storage cores with the corresponding relationship are connected.

4. The many-core processing apparatus according to claim 3, wherein the storage chip group comprises at least one non-volatile storage chip and/or at least one volatile storage chip arranged in a stacked manner;
or, the storage chip group comprises a plurality of volatile storage chips arranged in a stacked manner;
or, the storage chip group comprises a plurality of non-volatile storage chips arranged in a stacked manner.

5. The many-core processing apparatus according to claim 4, wherein at least part of the computing cores in the first chip forms a first array, at least part of first storage cores in the volatile storage chip forms a second volatile storage array, and at least part of second storage cores in the non-volatile storage chip forms a second non-volatile storage array;
in a case where the storage chip group comprises at least one non-volatile storage chip and at least one volatile storage chip arranged in a stacked manner, there is a corresponding relationship between the computing cores in the first array and the first storage cores in the second volatile storage array, and between the first storage cores in the second volatile storage array and the second storage cores in the second non-volatile storage array, and the computing cores and the first storage cores as well as the first storage cores and the second storage cores with the corresponding relationship are connected;
in a case where the storage chip group comprises a plurality of volatile storage chips arranged in a stacked manner, there is a corresponding relationship between the computing cores in the first array and the first storage cores in the second volatile storage array, and between the first storage cores in different second volatile storage arrays, and the computing cores and the first storage cores as well as the first storage cores in different second volatile storage arrays with the corresponding relationship are connected;
in a case where the storage chip group comprises a plurality of non-volatile storage chips arranged in a stacked manner, there is a corresponding relationship between the computing cores in the first array and the second storage cores in the second non-volatile storage array, and between the second storage cores in different second non-volatile storage arrays, and the computing cores and the second storage cores as well as the second storage cores in different second non-volatile storage arrays with the corresponding relationship are connected.

6. The many-core processing apparatus according to claim 1, wherein the computing cores of the first chip comprise first routing nodes, and the computing cores are connected to each other through the first routing nodes, the storage cores of the second chip stacked adjacent to the first chip comprise second routing nodes, and the storage cores are connected to each other through the second routing nodes;
the computing cores and the storage cores are connected through corresponding first and second routing nodes;
wherein at least part of the storage core comprises a cache unit and/or a storage unit, and the computing core connected to the storage core reads data from the cache unit through pre-reading.

8. (canceled).

9. The many-core processing apparatus according to claim 1, wherein at least part of the storage cores comprises a second routing node, and a plurality of storage cores establish connections through their respective second routing nodes to form a storage core cluster;
wherein the computing cores connected to at least one storage core in the storage core cluster use storage resources of at least one storage core in the storage core cluster through connections between the second routing nodes in the storage core cluster.

10. (canceled)

11. The many-core processing apparatus according to claim 1, wherein at least one second chip is provided with a controller, the controller is configured to control transmission of data within and between at least part of the chips in the many-core processing apparatus;
the second chips are connected through the controller, and at least one computing core in the first chip is connected to at least one storage core in the storage chip group.

12. The many-core processing apparatus according to claim 11, wherein the controller comprises a general controller and/or a sub-controller;
the general controller is at least configured to control the plurality of storage cores in the second chip where it is located, and the sub-controller is at least configured to control at least one storage core in the second chip where it is located.

13. The many-core processing apparatus according to claim 12, wherein the storage chip group comprises at least one non-volatile storage chip and at least one volatile storage chip arranged in a stacked manner, the at least one non-volatile storage chip is provided with a first general controller, the at least one volatile storage chip is provided with a second general controller, and the first general controller is connected to the second general controller;
the computing cores are connected to the storage cores in the non-volatile storage chip provided with the first controller and/or the storage cores in the volatile storage chip provided with the second general controller.

14. The many-core processing apparatus according to claim 13, wherein the storage chip group comprises a plurality of non-volatile storage chips and a plurality of volatile storage chips arranged in a stacked manner, the plurality of the non-volatile storage chips are stacked in sequence to form a first chip group, the plurality of the volatile storage chips are stacked in sequence to form a second chip group, and the first chip group, the second chip group, and the first chip are stacked in sequence;
the first general controller corresponding to the first chip group is arranged on the non-volatile storage chip stacked adjacent to the volatile storage chip, and the first general controller is connected to a plurality of storage cores in the first chip group for controlling the plurality of storage cores which are connected;
the second general controller corresponding to the second chip group is arranged on the volatile storage chip stacked adjacent to the first chip, and the second general controller is connected to a plurality of storage cores in the second chip group for controlling the plurality of storage cores which are connected;
the computing cores are connected to the storage cores in the volatile storage chip stacked adjacent to the first chip.

15. The many-core processing device according to claim 12, wherein the storage chip group comprises at least one non-volatile storage chip and at least one volatile storage chip arranged in a stacked manner, the at least one non-volatile storage chip is provided with a plurality of first sub-controllers, and the at least one volatile storage chip is provided with a plurality of second sub-controllers;
the storage cores in the non-volatile storage chip have a corresponding relationship with the storage cores in the volatile storage chip, and the first sub-controller and second sub-controller of the storage cores having the corresponding relationship are connected;
a processing unit is provided in the computing core, the processing unit is connected to at least one first sub-controller and/or at least one second sub-controller, and is configured to send data operation instructions to the connected first sub-controller and/or second sub-controller, so that the first sub-controller and/or second sub-controller process data in the corresponding storage core based on the data operation instructions.

16. The many-core processing apparatus according to claim 15, wherein the storage chip group comprises a plurality of non-volatile storage chips and a plurality of volatile storage chips arranged in a stacked manner, the plurality of non-volatile storage chips are stacked in sequence to form a third chip group, the plurality of volatile storage chips are stacked in sequence to form a fourth chip group, and the third chip group, the fourth chip group and the first chip are stacked in sequence;
the storage cores in the non-volatile storage chip stacked adjacent to the volatile storage chip have a corresponding relationship with at least one storage core in other non-volatile storage chips in the third chip group, and the storage cores with the corresponding relationship constitute a first storage core cluster, at least part of the first storage core clusters is connected to the first sub-controller, and the first sub-controller is arranged in the non-volatile storage chip stacked adjacent to the volatile storage chip; the storage cores in the volatile storage chip stacked adjacent to the first chip have a corresponding relationship with at least one storage core in other volatile storage chips in the fourth chip group, and the storage cores with the corresponding relationship constitute a second storage core cluster, at least part of the second storage core clusters is connected to the second sub-controller, and the second sub-controller is arranged in the volatile storage chip stacked adjacent to the first chip.

17. The many-core processing apparatus according to claim 12, wherein the storage chip group comprises a plurality of volatile storage chips arranged in a stacked manner, the storage cores in the volatile storage chip stacked adjacent to the first chip have a corresponding relationship with at least one storage core in other volatile storage chips in the storage chip group, and the storage cores having the corresponding relationship constitute a third storage core cluster, at least part of the third storage core clusters is connected to a third sub-controller, the third sub-controller is arranged on the volatile storage chip stacked adjacent to the first chip, and the computing cores in the first chip are connected to the storage cores in the volatile storage chip stacked adjacent to the first chip; or,
the storage chip group comprises a plurality of non-volatile storage chips arranged in a stacked manner, the storage cores in the non-volatile storage chip stacked adjacent to the first chip have a corresponding relationship with at least one storage core in other non-volatile storage chips in the storage chip group, and the storage cores with the corresponding relationship constitute a fourth storage core cluster, at least part of the fourth storage core clusters is connected to a fourth sub-controller, the fourth sub-controller is arranged on the non-volatile storage chip stacked adjacent to the first chip, and the computing cores in the first chip are connected to the storage cores in the non-volatile storage chip stacked adjacent to the first chip.

18. The many-core processing apparatus according to claim 12, wherein the storage chip group comprises a plurality of volatile storage chips arranged in a stacked manner, a third general controller is arranged in the volatile storage chip stacked adjacent to the first chip, the third general controller is configured to control a plurality of storage cores in the storage chip group, and the computing cores in the first chip are connected to the storage cores in the volatile storage chip stacked adjacent to the first chip; or,
the storage chip group comprises a plurality of non-volatile storage chips arranged in a stacked manner, a fourth general controller is arranged in the non-volatile storage chip stacked adjacent to the first chip, the fourth general controller is configured to control a plurality of storage cores in the storage chip group, the computing cores in the first chip are connected to the storage cores in the non-volatile storage chip stacked adjacent to the first chip.

19. The many-core processing apparatus according to claim 4, wherein in a case where the storage chip group comprises at least one non-volatile storage chip and at least one volatile storage chip arranged in a stacked manner, storage space of the non-volatile storage chip is larger than storage space of the volatile storage chip, and the storage space of the volatile storage chip is larger than storage space of the first chip;
in a case where the storage chip group comprises a plurality of volatile storage chips arranged in a stacked manner, the storage space of the volatile storage chip is larger than the storage space of the first chip;
in a case where the storage chip group comprises a plurality of non-volatile storage chips arranged in a stacked manner, the storage space of the non-volatile storage chip is larger than the storage space of the first chip;
wherein the storage space of the first chip is composed of independent storage spaces of the plurality of computing cores.

20. A data processing method, wherein the method is applied to the many-core processing apparatus according to claim 1, the many-core processing apparatus comprises a first chip and at least one second chip arranged in a stacked manner, the first chip comprises a plurality of computing cores, the at least one second chip forms a storage chip group, the second chip comprises a plurality of storage cores, and at least one computing core is connected to at least one storage core; the method comprising:
in response to received data operation instructions, processing data in a corresponding storage core.

23. (canceled).

24. An electronic device, comprising a memory, a processor, and a computer program stored in the memory and executable on the processor, wherein when the processor executes the computer program, the data processing method according to claim 1 is implemented.

25. A non-transitory computer-readable storage medium having a computer program stored thereon, wherein when the computer program is executed by a processor, the data processing method according to claim 1 is implemented.

26. A computer program product, comprising computer-readable code or a non-volatile computer-readable storage medium carrying the computer-readable code, wherein, when the computer-readable code runs in a processor of an electronic device, the processor in the electronic device executes the data processing method according to claim 1.
